(19) United States
(12) Patent Application Publication
(10) Pub. No.: US 2002/0094157 A1
(43) Pub. Date: Jul. 18, 2002

(54) Polarization dependent filtering device utilizing a fabry-perot cavity

(76) Inventor: Jimin Xie, Ottawa (CA)

Correspondence Address: JDS UNIPHASE CORPORATION, INTELLECTUAL PROPERTY DEPARTMENT, 3000 MERIVALE ROAD, OTTAWA, ON, K2G 6N7, CA

(21) Appl. No.: 09/758,119

(22) Filed: Jan. 12, 2001

(51) Int. Cl. G02B 6/27

(52) U.S. Cl. 385/27; 385/11; 385/15

(57) ABSTRACT

A circuit is disclosed wherein two beams exiting opposite ends of an optical resonant cavity, such as a Fabry-Perot (F-P) etalon for example, are provided via unguided light directing means to a combining region where the beams can interfere with one another to provide a desired output response. In one embodiment, multiplexed channels of light can be demultiplexed by the device described heretofore, or alternatively, the phase relationship between these two beams can be altered prior to their being combined to provide, for example, a linearized output response useful in applications such as wavelength locking. By varying the reflectivity of the optical cavity reflectors and/or by varying the phase relationship between the two beams exiting the optical cavity, a variety of desired output responses can be realized.

### FIELD OF THE INVENTION

This invention relates generally to a filtering device and more particularly to a polarization dependent filtering device that utilizes an optical cavity having at least three-ports.

### BACKGROUND OF THE INVENTION

Using optical signals as a means of carrying channeled information at high speeds through an optical path such as an optical waveguide i.e. optical fibers, is preferable over other schemes such as those using microwave links, coaxial cables, and twisted copper Electro-Magnetic Interference (EMI), and have higher channel capacities. High-speed wires, since in the former, propagation loss is lower, and optical systems are immune to optical systems have signaling rates of several mega-bits per second to several tens of giga-bits per second.

Optical communication systems are nearly ubiquitous in communication networks. The expression herein “Optical communication system” relates to any system that uses optical signals at any wavelength to convey information between two points through any optical path.

As communication capacity is further increased to transmit an ever-increasing amount of information on optical fibers, data transmission rates increase and available bandwidth becomes a scarce resource.

High speed data signals are plural signals that are formed by the aggregation (or multiplexing) of several data streams to share a transmission medium for transmitting data to a distant location. Wavelength Division Multiplexing (WDM) is commonly used in optical communications systems as means to more efficiently use available resources. In WDM each high-speed data channel transmits its information at a pre-allocated wavelength on a single optical waveguide. At a receiver end, channels of different wavelengths are generally separated by narrow band filters and then detected or used for further processing. In practice, the number of channels that can be carried by a single optical waveguide in a WDM system is limited by crosstalk, narrow operating bandwidth of optical amplifiers and/or optical fiber non-linearities. Moreover such systems require an accurate band selection, stable tunable lasers or filters, and spectral purity that increase the cost of WDM systems and add to their complexity. This invention relates to a method and system for filtering or separating closely spaced channels that would otherwise not be suitably filtered by conventional optical filters.

Currently, internationally agreed upon channel spacing for high-speed optical transmission systems, is 100 GHz, equivalent to 0.8 nm, surpassing, for example 200 GHz channel spacing equivalent to 1.6 nanometers between adjacent channels. Of course, as the separation in wavelength between adjacent channels decreases, the requirement for more precise demultiplexing circuitry capable of ultra-narrow-band filtering, absent crosstalk, increases. The use of conventional dichroic filters to separate channels spaced by 0.4 nm or less without crosstalk, is not practicable; such filters being difficult if not impossible to manufacture.

In a paper entitled “Multifunction optical filter with a Michelson-Gires-Tournois interferometer for wavelength-division-multiplexed network system applications”, by Benjamin B. Dingle and Masayuki Izutsu published 1998, by the Optical Society of America, a device hereafter termed the GT device was discussed. The GT device, as exemplified in FIG. 1, serves as a narrow band wavelength demultiplexer. That is, this device relies on interfering an E-field reflected from a GT with an E-field reflected by a plane mirror 16. The etalon 10 used has a 99.9% reflective back reflector 12r and a front reflector 12f having a reflectivity of about 10%; hence an output signal from only the front reflector 12f is utilized. A beam splitting prism (BSP) 18 is disposed to receive an incident beam and to direct the incident beam to the etalon 10. The BSP 18 further receives light returning from the etalon and provides a portion of that light to the plane mirror 16 and a remaining portion to an output port. For the GT device a finite optical path difference is required in the interferometer in order to produce an output response and is typically a few millimeters for a 50 GHz free spectral range (FSR) system. In contrast, the invention disclosed in U.S. Pat. No. 6,125,220, issued in the name of Copner et al., herein incorporated by reference, needs an optical phase difference of only approximately λ/4 resulting in a more temperature stable and temperature insensitive system. A further limitation of the GT device is its apparent requirement in the stabilization of both the etalon and the interferometer. Yet a further drawback to the GT device is the requirement for an optical circulator to extract the output signal adding to signals loss and increased cost of the device and the requirement of a BSP which is known to have a significant polarization dependent loss.

In general, the spectral characteristics of an etalon filter are determined by the reflectivity and gap spacing of the mirrors or reflective surfaces. The Fabry-Perot principle allows a wide band optical beam to be filtered whereby only periodic spectral passbands are substantially transmitted out of the filter. Conversely, if the reflectivity of the mirrors or reflective surfaces are selected appropriately, periodic spectral passbands shifted by d nanometers are substantially reflected backwards from the input mirror surface. In adjustable Fabry-Perot devices, such as one disclosed in U.S. Pat. No. 5,283,845 in the name of Ip, assigned to JDS Fitel Inc, tuning of the center wavelength of the spectral passband is achieved typically by varying the effective cavity length (spacing).

Referring now to FIG. 2, an optical circuit is shown for demultiplexing a channeled optical signal, that is, a signal comprising multiplexed closely spaced channels, into a plurality of less-dense channeled signals each comprising a plurality of multiplexed less closely spaced channels. Operating the circuit in a first direction wherein the circuit performs a multiplexing function on a plurality of channels launched into an end of the circuit, it is an interleaver circuit, and in an opposite direction wherein the circuit performs a demultiplexing function on a composite signal launched therein at an opposite end to provide a plurality of demultiplexed channels it serves as a de-interleaver circuit. However, the term interleaver circuit shall be used hereafter to denote this interleaver/de-interleaver circuit. One such interleaver circuit is disclosed as a comb splitting filter in U.S. Pat. No. 5,680,490 in the name of Cohen.

In FIG. 2, an optical interleaver circuit is shown including a 3-port optical cavity in the form of a Fabry-Perot etalon filter 110 (shown in more detail in FIG. 3) having a first partially reflective end face 110a and a second partially reflective end face 110b. The Fabry-Perot etalon has an input port 101 at end face 110b, a first output port 102 at the Fabry-Perot etalon filter reflection end face 110b, and a second output port 103 coupled to a transmission end face 110a. The Fabry-Perot etalon filter 110 has two partially reflective mirrors, or surfaces, facing each other and separated by a certain fixed gap which forms a cavity. A phase shifter 117 for controllably delaying an optical signal passing therethrough is optically coupled with the second output port 103 at an end of the Fabry-Perot etalon 110. A 50/50 splitter 119 is disposed between and optically coupled with an output end of the phase shifter 117 and the first output port 102 of the Fabry-Perot etalon 110. Of course coupling lenses (not shown) such as GRIN lenses are preferred for coupling light from and or to optical fibers from particular components.

In U.S. Pat. No. 6,125,220, issued to Copner et al., it was noted that a phase difference between the reflected and transmitted E-field phase from an etalon, for example, the etalon 110, remains constant under certain circumstances. Furthermore, when input light is launched into the input port 101 of the etalon, the phase difference between a resulting signal exiting the end face 103 and a resulting signal exiting the end face 102 is either 0 or π radians, and changes on every spectral transmission resonance. The locking of the phase difference between transmitted and reflected E-fields occurs due to multiple interference effects within the etalon. The invention illustrated in FIG. 2 utilizes this feature by the use of constructive and destructive interference to beat the two resulting signals against each other to produce a resulting signal that has a flat spectral passband. The filter so realized is referred to as a flat spectral bandpass filter. The use of constructive and destructive interference of two signals beat together to produce a resulting signal is hereafter referred to as interfering. By adjusting the phase relationship between the two signals exiting opposing faces of the Fabry-Perot etalon 110, and subsequently interfering these signals, various desired output responses can be realized. For example, channel selection can be realized when the circuit operates as a de-interleaver filter, providing the separation of odd channels at one output of the 50/50 splitter and even channels at a second output of the 50/50 splitter.

### SUMMARY OF THE INVENTION

In accordance with the invention, there is provided a filtering device comprising:

an optical resonant cavity having a first and a second partially transmissive reflector, said optical resonant cavity having a first port disposed at the first partially transmissive reflector and a second port disposed at the second partially transmissive reflector;

means for combining light beams, said means being optically coupled with the first and second ports of the optical resonant cavity, said means being capable of combining light beams exiting the first and second ports so that said light beams interfere to provide one or more output beams of light; and,

light directing means configured for optically coupling, in free space, the means for combining light beams and the optical resonant cavity.

In accordance with another aspect of this invention, there is provided a method of filtering an input beam comprising multiplexed channels of light each occupying a predetermined wavelength band, the method comprising the steps of:

launching the input beam through a polarization dependent reflector into an optical resonant cavity to provide two output beams;

modifying the polarization of the output beams;

folding the output beams by reflection at a polarization dependent reflector;

interfering said output beams to provide filtered output beams;

modifying the polarization of the filtered output beams to allow transmission at a polarization dependent reflector.

### BRIEF DESCRIPTION OF THE DRAWINGS

Exemplary embodiments of the invention will now be described in conjunction with the drawings in which:

FIG. 1 is a circuit block diagram of a prior art Michelson-Gires-Tournois interferometer;

FIG. 2 is a prior art circuit block diagram of a single etalon interferometric structure;

FIG. 3 is a more detailed prior art diagram of the etalon shown in FIG. 2;

FIG. 4 is a detailed block diagram depicting an embodiment of the present invention;

FIG. 5a is a detailed block diagram depicting an alternative embodiment of the present invention;

FIG. 5b is a detailed block diagram depicting an alternative embodiment of the present invention;

FIG. 5c is a detailed block diagram depicting an alternative embodiment of the present invention;

FIG. 6a is a graph illustrating the signal at OUT 1 from the block diagram of FIG. 5c;

FIG. 6b is a graph illustrating the signal at OUT 2 from the block diagram of FIG 5c;

FIG. 7 illustrates a pair of prisms for optical path adjusting of the present invention;

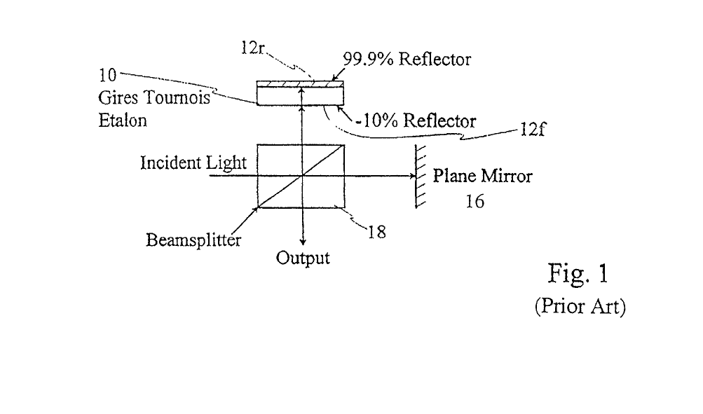

### DETAILED DESCRIPTION

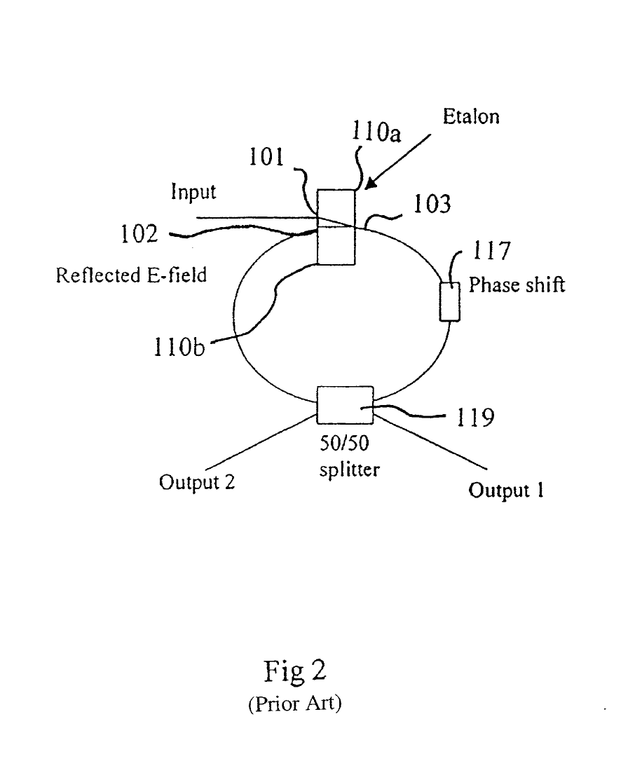

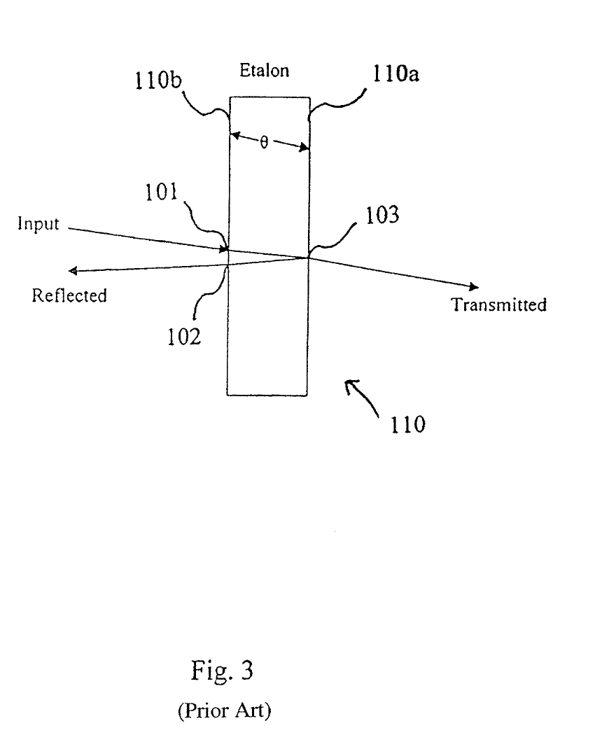

The principle of the symmetric Fabry-Perot (F-P) etalon based interleaver is depicted in prior art FIG. 2 with a more detailed presentation of the etalon in FIG. 3. FIG. 3 shows a 3-port optical cavity in the form of a Fabry-Perot etalon filter 110 having a first partially reflective end face 110a and a second partially reflective end face 110b. The Fabry-Perot etalon has an input port 101 at end face 110b, a first output port 102 at the Fabry-Perot etalon filter reflection end face 110b, and a second output port 103 coupled to a transmission end face 110a. The Fabry-Perot etalon filter 110 has two partially reflective mirrors, or surfaces, facing each other and separated by a certain fixed gap which forms a cavity, typically 5 times the channel center wavelength, λ_{c}. The transmissive and reflective beams of the interferometer with relative phase shift between them are combined using a 50/50 coupler (splitter in the prior art). A flat spectral bandpass filter is obtained when the relative phase shift is (k+0.5)π where k is an integer. Finesse is a measure of the resolving power of an etalon. When the finesse of the etalon is low the cavity produces sinusoidal waveforms for both the reflected and transmitted light rather than narrow peaks. When these sinusoidal waveforms are beat together, that is interfered, the result is a signal with a flat maximum and the maxima are separated by 2λ. The interfering takes place in the coupling region of the interface of the coupler. Said coupler may be a thin film, which is actually several thin films one on top of another, but could also be a fiber coupler or a waveguide coupler. These details are explained in U.S. Pat. No. 6,125,220, issued to Copner et al, herein incorporated by reference. Previous arrangements, some of which are illustrated in the prior art figures, use non-polarized light to realize a Fabry-Perot based interleaver. The manufacturing tolerances of such an interleaver are very strict and difficult to realize. The instant invention overcomes these limitations by using polarized light to realize a Fabry-Perot based interleaver. The new structure uses the state of polarization of the beam of light to effect the routing of the beam of light. Also the new structure allows for a mechanism to adjust the phase in the assembly stage. This allows for channel center wavelength, λ_{c}, and flat bandpass conditions to be adjusted for separately.

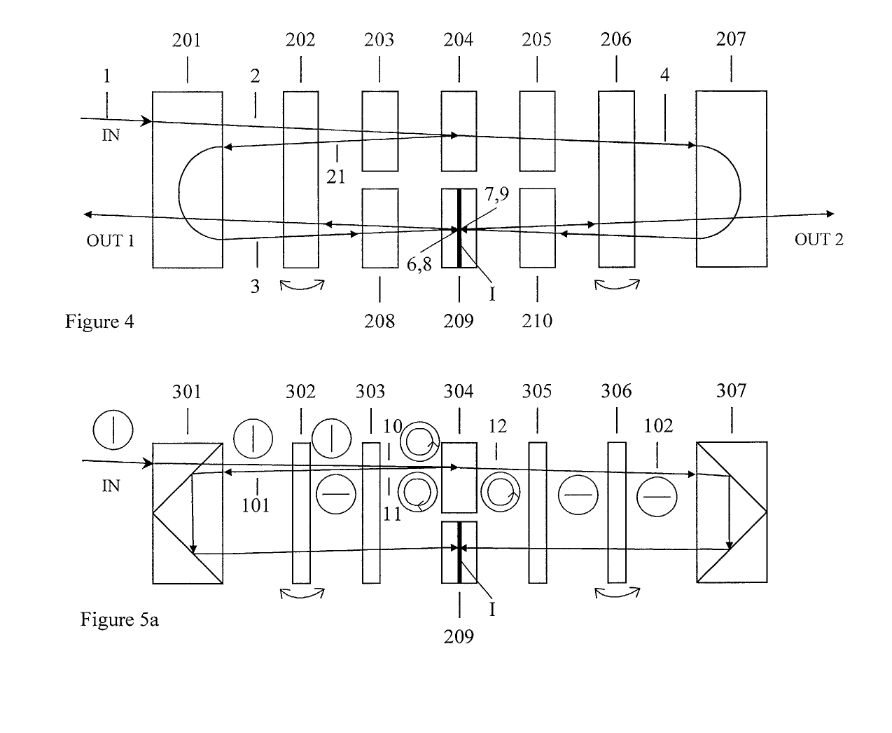

Referring to FIG. 4, a linear polarized beam of light 1 passes through a polarization selective optical element 201. The polarization selective element 201 can be a polarization beam splitter or a crystal based polarization beam shifter. Each element 201 and 207 are also referred to herein as a polarization dependent reflector since they transmit light of a first polarization and reflect light of a second polarization, said second polarization being orthogonal to the first polarization. The optical axis of element 201 is chosen such that all light of a first polarization passes through without loss and light of an orthogonal polarization to the first polarization is completely reflected. Optical element 202 has no polarization dependent effect but contributes to the optical path length adjustment process as does optical element 206, i.e. the tuning of the filter via tilting these elements in the optical path. Optical element 203 and 205 are polarization rotators and sandwich a symmetric Fabry-Perot (F-P) interferometer 204. The combined effect of optical element 203 and F-P 204 on the beam 21 reflected by F-P 204 is a change in polarization by 90° with respect to the beam 2 incident to the F-P 204. The combined effect of optical elements 204, and 205 changes the polarization of the transmitted beam 4 by 90° to the incident beam 2. The polarization rotators 203 and 205 can either be a quarter waveplate or a Faraday rotator. The reflected beam 21 having passed through element 203 twice has a polarization orthogonal to the incident beam 2 and therefore is reflected by element 201 and passes through element 208 and impinges on optical element 209. Optical elements 208 and 210 are polarization rotators and they sandwich optical element 209, a 50/50 splitter/coupler, hereafter referred to as a coupler. Optical elements 203 and 208 can be the same element as can optical elements 205 and 210. Beam 3 passes through optical element 208 and impinges on optical element 209. 50% of beam 3 is transmitted through optical element 209, as beam 7 and 50% of it is reflected by optical element 209 as beam 6. Going back to the etalon, the portion of beam 2 that was transmitted by F-P 204 passes through optical element 205, changing the state of polarization of the beam 4 by 90° compared to beam 2. It then passes through element 206 and since it no longer has the polarization of beam 2 it is reflected by optical element 207. Beam 4 then passes through optical element 210 and impinges on optical element 209, a 50/50 coupler, resulting in 50% of beam 4 passing through becoming beam 8 and 50% being reflected to form beam 9. The optical path of the system is designed such that the optical paths of beams 6 and 8 coincide, i.e., overlap, allowing constructive and destructive interference between the two beams. This interference take place inside of the interface I of optical element 209 and results in a beam with a flat top broad band signal with maxima spaced at 2λ. This interfered beam is then pass through element 208, undergoing a 90° phase shift with respect to the polarization state of beam 3, which then allows the interfered beam to pass through optical element 201 to form the signal OUT 1. Also the optical paths of beams 7 and 9 coincide, inside of the interface I of optical element 209, and the resulting interfered beam then passes through element 210, undergoing a 90° phase shift with respect to the polarization state of beam 4, which then allows the interfered beam to pass through optical element 207 to form the signal OUT 2.

Optical elements 202 and 206 are for tuning the optical path and for stabilization of the overall optical system. Elements 202 and 206 are positioned such that the optical path difference is (k+0.5)π between the beam from the reflection surface of the F-P interferometer 204 to the 50/50 coupler 209 interface I and the beam from the transmission surface of the F-P interferometer 204 to the 50/50 coupler 209 interface I. The optical element pair 202 and 206 are designed such that the optical path difference is stable for different environmental conditions, e. g. temperature variation. In this case, the temperature caused optical path change through refractive index change, dn/dT, and thermal expansion will be very weak. Within the temperature variation range for telecom components, the device shows an athermal effect. Further, these glass elements are Zerodur or ULE (ultra low expansion) both of which are trade names of a specific type of glass.

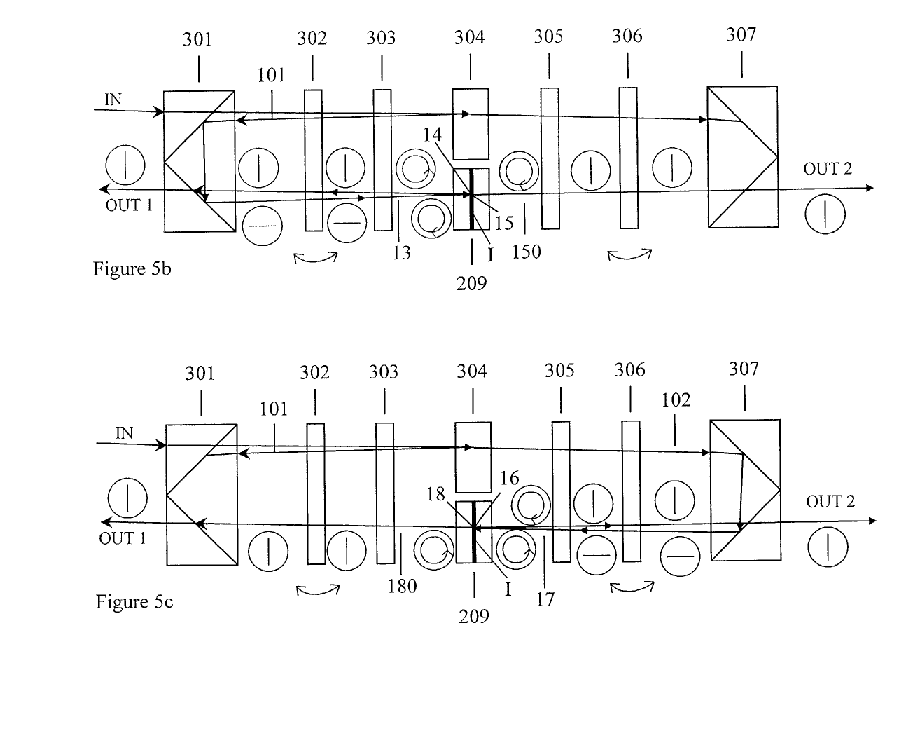

The embodiments presented herein use linearly polarized light of a first and a second polarization, the second polarization being orthogonal to the first, to control whether light will be reflected by or transmitted through the polarization dependent reflectors. However, in the intermediate stages of the filtering device of FIGS. 4, 5a, 5b, and 5c the light beam will be of mixed polarization. It may be right circularly polarized, or left circularly polarized but once it has passed through two polarization rotators it will have a second polarization which is orthogonal to the first polarization. The embodiments presented herein use polarization dependent reflectors that pass vertically polarized light and reflect horizontally polarized light. They could just as well do the opposite and are not intended to restrict the invention herein. Also note that the polarization dependent reflectors do not have to have a 90° between the two surfaces.

Now referring to FIG. 5a, the polarization beam splitter (PBS) 301 has its transmissive polarization direction parallel to the polarization direction of the linearly polarized input beam (e.g. vertical). The quarter waveplate (QWP) 303 changes the linear polarization to circular polarization with its optical axis 45° relative to the input beam polarization. The phase induced by the partial reflective coating of the F-P interferometer 304 is designed to change the phase of the reflected beam by 180°, while the phase of the transmitted beam is unaffected. When the reflected beam passes through the QWP element 303, it becomes horizontally polarized linear light. Therefore, the PBS 301 reflects beam 101 towards the 50/50 coupler 209. QWP 305 on the right side of F-P 304 has the same optical axis orientation as the QWP 303 on the left side of F-P 304. Beam 12 is transmitted through F-P 304 and becomes horizontally polarized after passing through QWP 305 becoming beam 102. Beam 102 is then reflected by PBS 307 towards the coupler 209.

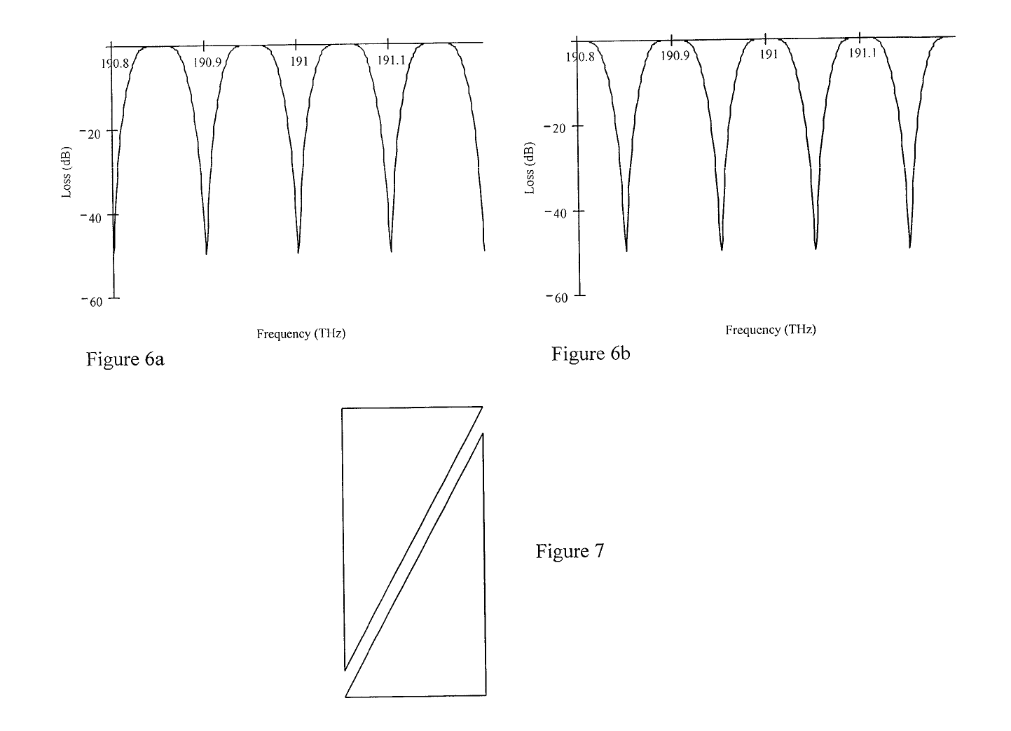

Now referring to FIG. 5b, PBS 301 reflects beam 101, which then passes through element 302 and QWP 303 becoming circularly polarized beam 13. Beam 13 impinges on optical coupler 209 and 50% is transmitted through 209 to become beam 15 while 50% is reflected at 209 to become beam 14. Additionally, referring to FIG. 5c, a similar scenario happens to beam 102, that was transmitted by the F-P 304, and is reflected by PBS 307 becoming beam 17. 50% of beam 17 is transmitted through 50/50 coupler 209 becoming beam 18 and 50% is reflected by 50/50 coupler 209 becoming beam 16. On the left side optical element 302 is tilted to adjust the phase relationship between 14 and 18 and on the right side optical element 306 is tilted to adjust the phase relationship between 15 and 16. Thus both optical element 302 and optical element 306 are tiltable as noted by arrows in FIGS. 4, 5a, 5b, and 5c. These adjustments are done to keep the phase relationship constant under different ambient temperatures. Thus the optical paths of beams 14 and 18 coincide, inside the interface I of coupler 209, and allow for interference of the two beams. The resulting interfered beam 180, FIG. 5c, passes through optical element 303 undergoing a phase change that allows this filtered output to pass through PBS 301 as output OUT 1. Also, the optical paths of beams 15 and 16 coincide, inside the interface I of coupler 209, and allow for interference of the two beams. The resulting interfered beam 150, FIG. 5b, passes through optical element 305 undergoing a phase change that allows this filtered output to pass through PBS 307 as output OUT 2. Therefore when channels having center wavelengths λ₁, λ₂, λ₃, λ₄, . . . λₙ are launched into IN of left side PBS 301, the channels are de-interleaved to OUT 1 and OUT 2 into channel groups λ₁, λ₃, λ₅, . . . and λ₂, λ₄, λ₆, . . . , respectively, thereby providing two de-interleaved groups. This is illustrated in FIGS. 6a and 6b for the outputs from FIGS. 5b and 5c, OUT 1 and OUT 2, respectively.

The quarter waveplates 303 and 305 can be replaced with Faraday rotators accompanied with a change of optical axis to 22.5° relative to the polarization direction of the input beam. The optical axis of the Faraday rotator on the right side of F-P 304 should be perpendicular to the optical axis of the Faraday rotator on the left side of the F-P 304.

For a given F-P etalon, the transmission (reflection) peak can be adjusted to the ITU (International Telecommunication Union) grid, i.e. the channel spacing, by changing the oscillated beam phase inside the cavity by changing the incident beam angle, the optical path length, or the coating phase condition. The phase shifter can also be realized using one or two triangle prisms, as in FIG. 7, in the optical path. That is a pair of prisms would be used to replace each tuning glass plate, 202, 206 of FIG. 4 and 302 and 306 of FIGS. 5a, 5b, and 5c. Moving the relative position of the two triangle prisms up and down changes the optical path. Temperature stabilization can also be done using a compensation design based on thermal expansion effect and material refractive index temperature effect.

By changing the phase relationship between the signals in the two arms of the circuit, being fed to the 50/50 coupler, and by changing the reflectivities of the end faces of the etalon, for example to have 60% and 1% reflectivities, the interleaving function disappears and the circuit operates to provide a linearized output. Such a linearized output signal is useful in such applications as wavelength locking, where a linear ramped signal is desired. Furthermore, if the two output signals are subtracted from one another, the effect is further enhanced since no loss of the signal will be induced.

Of course numerous other embodiments may be envisaged, without departing from the spirit and scope of the invention. For example, the etalon can be a tunable etalon.

What is claimed is:

1. A filtering device comprising:
an optical resonant cavity having a first and a second partially transmissive reflector, said optical resonant cavity having an input port, a first output port disposed at the first partially transmissive reflector and a second output port disposed at the second partially transmissive reflector;
means for combining light beams, said means being optically coupled with the first and second output ports of the optical resonant cavity, said means being capable of combining light beams exiting the first and second output ports so that said light beams interfere to provide one or more output beams of light; and,
light directing means configured for optically coupling, in free space, the means for combining light beams and the optical resonant cavity.

2. A filtering device as defined in claim 1, wherein the light directing means comprises:
first and second polarization dependent reflectors which transmit light of a first polarization while reflecting light of a second polarization; and
rotator means disposed between first and second polarization dependent reflectors and the optical resonant cavity, said rotator means for rotating the polarization of a beam of light from a first polarization to a second polarization, said second polarization being orthogonal to the first polarization.

3. A filtering device as defined in claim 2, wherein the first and second polarization dependent reflectors are polarization beam splitters.

4. A filtering device as defined in claim 2, wherein the rotator means is a quarter waveplate for changing the polarization of the beam of light from a first polarization to second polarization, said beam having passed twice through the quarter waveplate.

5. A filtering device as defined in claim 2, further comprises phase difference tuning means to tune the filtering device to compensate for the refractive index change of the optical components with respect to a change in temperature.

6. A filtering device as defined in claim 5, wherein said tuning means are glass plates inserted in the optical path and tiltable at an angle to the optical path.

7. A filtering device as defined in claim 1, wherein the first and second partially transmissive reflectors are adapted to filter an optical signal having a channel having a center wavelength of λ_{c} and wherein the first and second partially transmissive reflectors are disposed at least 5λ_{c} apart.

8. A filtering device as defined in claim 7, wherein the optical cavity is an etalon, and wherein the first and second partially transmissive reflectors are first and second end faces of the etalon, respectively.

9. A filtering device as defined in claim 8, wherein the optical cavity is a Fabry-Perot etalon.

10. A filter device as defined in claim 9, wherein the Fabry-Perot etalon is a low finesse etalon.

11. A method of filtering an input beam comprising multiplexed channels of light each occupying a predetermined wavelength band, the method comprising the steps of:
launching the input beam through a polarization dependent reflector into an optical resonant cavity to provide two output beams;
modifying the polarization of the output beams;
folding the output beams by reflection at a polarization dependent reflector;
interfering said output beams to provide filtered output beams;
modifying the polarization of the filtered output beams to allow transmission at a polarization dependent reflector.

12. A method of filtering an input beam comprising multiplexed channels of light each occupying a predetermined wavelength band, the method comprising the steps of:
launching the input beam through a polarization dependent reflector into an optical resonant cavity to provide a first and a second output beam;
passing the first and second output beams through a polarization rotating means to change the polarization of the first and second output beams to allow reflection from the polarization dependent reflectors;
reflecting the first and second output beams from the polarization dependent reflectors such as to provide directing said first and second reflected beams into the beam coupler;
interfering said first and second reflected beams to produce two filtered outputs;
passing the first and second filtered output beams through a polarization rotating means to change the polarization of the first and second filtered output beams to allow transmission at the polarization dependent reflectors.

13. A method of filtering an input beam, having a first polarization, comprising multiplexed channels of light each occupying a predetermined wavelength band, the method comprising the steps of:
modifying the input beam to have a mixed polarization different from the first polarization and providing the modified input beam to an optical resonant cavity having a first and a second partially transmissive reflector, said optical resonant cavity having an input port, a first output port disposed at the first partially transmissive reflector and a second output port disposed at the second partially transmissive reflector;
changing the mixed polarization of a first and a second output beam, from the first and second output ports of the optical resonant cavity, respectively, to a second polarization orthogonal to the first polarization thereby allowing polarization dependent reflecting of said beams; and
changing the polarization of the first and second polarization dependent reflected beams to a mixed polarization different from the second polarization and interfering these modified first and second polarization dependent reflected beams to produce one or more filtered output beams, said filtered output beams then modified to have a first polarization.
